(19) United States
(12) Patent Application Publication
(10) Pub. No.: US 2008/0100571 A1
(43) Pub. Date: May 1, 2008

(54) HUMAN INTERFACE DEVICE

(76) Inventor: Percival Christoffel MILLS, Pretoria (ZA)

Correspondence Address: DALINA LAW GROUP, P.C., 7910 IVANHOE AVE. #325, LA JOLLA, CA, 92037, US

(21) Appl. No.: 11/876,685

(22) Filed: Oct. 22, 2007

(30) Foreign Application Priority Data
Oct. 28, 2006 (ZA) ZA2006/06212

(51) Int. Cl. G09G 5/00

(52) U.S. Cl. 345/156

(57) ABSTRACT

A human interface device 10 including a base member 12 having a first 16 and second 18 surface, wherein the first surface 16 is an upper surface and is shaped and dimensioned to be received by a palmer aspect of a user's one hand (not shown), a plurality of sensors 14 configured to allow a user to carry out numerous functions on a peripheral device (not shown) connected to the human interface device 10. The plurality of sensors 14 are configured to allow a user (not shown) to at least enter text, format a document and/or manipulate a pointer on the peripheral device.

This application takes priority from South African Patent Application ZA2006/06212 filed 28 Oct. 2006, the specification of which is hereby incorporated herein by reference.

### BACKGROUND OF THE INVENTION

1. Field of the Invention

The present invention relates to a human interface device and in particular to a multifunctional human interface device.

2. Description of the Related Art

The inventor is a physically disabled person and is aware of the problems associated with using a mouse and keyboard when one does not have the advantage of using both hands.

Furthermore, the inventor is aware that it may be difficult for a person with low or increased muscle tone to have the ability to control and work on a traditional mouse and keyboard set-up.

The inventor is also aware that certain situations require an able bodied person to have a free hand whilst still being able to operate a computer keyboard and mouse.

The inventor believes that a need exists for a human interface device that a user can operate with one hand.

### BRIEF SUMMARY OF THE INVENTION

### Definitions

A human interface device—any device that serves as an interface between a human and a computer or peripheral device such as a keyboard, a mouse, a wireless sensor, a mobile phone, a notebook computer, a digital camera, and the like.

### Uni-dexterously—One handed

According to an aspect of the invention, there is provided a human interface device that includes a base member having a first and second surface, wherein the first surface is an upper surface and is shaped and dimensioned to be received by a palmer aspect of a user's hand, a plurality of sensors configured to allow the user to carry out numerous functions on a peripheral device connected to the human interface device and wherein the plurality of sensors are configured to allow the user to, uni-dexterously, at least enter text, format a document and/or manipulate a pointer on the peripheral device.

The second surface may be an under surface that is shaped and dimensioned to rest on and/or move relative to a work surface.

The base member may include translation means for translating movement of the human interface device relative the work surface to movement of a pointer on the peripheral device.

The translation means may include any one or more of a roller-ball mechanism, trackball, touchpad, infra red arrangements, optical arrangements and the like.

The first surface may include any one or more of a roller-ball mechanism, trackball, touchpad, infra red arrangements, optical arrangements and the like.

The first surface may include a heat and/or pressure sensitive sensor and the sensor may be configured to allow the user to move a pointer on the peripheral device without displacing the base member's position relative the work surface.

The first surface of the base member may define partitions for receiving at least one of a user's digits.

The sensors may be configured to allow a user to enter text, format documents, perform functions, manipulate a pointer on the peripheral device and the like.

The sensors may be one or more of conventional computer keyboard keys, heat sensors, touch sensors, touch screen sensors and the like.

Each sensor may be configured to allow entry of at least one letter of the alphabet or numeral.

The device may include securing means for securing a user's hand to the device.

### BRIEF DESCRIPTION OF THE DRAWINGS

The invention will now be described by way of non-limiting example with reference to the accompanying diagrammatic drawing, in which

FIG. 1 is a top view of the human interface device;

FIG. 2 is a side view of the human interface device;

FIG. 3 shows a perspective view of the invention;

FIG. 4 shows a top view of another embodiment of the invention; and,

FIG. 5 is a drawing of a plan view of yet another embodiment of the invention.

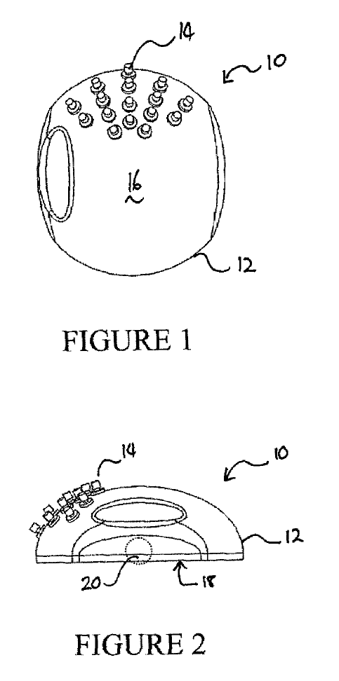

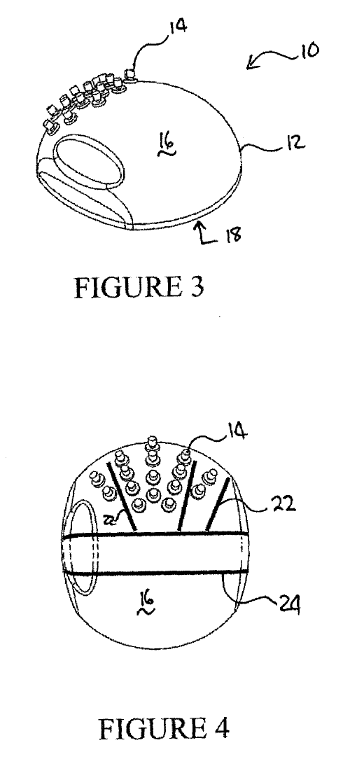

### DETAILED DESCRIPTION OF THE INVENTION

In the drawings, reference numeral 10 generally refers to a human interface device.

A human interface device 10 including a base member 12 having a first 16 and second 18 surface, wherein the first surface 16 is an upper surface and is shaped and dimensioned to be received by a palmer aspect of a user's one hand (not shown), a plurality of sensors 14 configured to allow a user to carry out numerous functions on a peripheral device (not shown) connected to the human interface device 10. The plurality of sensors 14 are configured to allow a user (not shown) to at least enter text, format a document and/or manipulate a pointer on the peripheral device.

The second surface 18 is a lower surface and is shaped and dimensioned to rest on and/or move relative to a work surface (not shown).

The base member 12 includes translation means 20 for translating movement of the human interface device 10, relative the work surface, to movement of a pointer on the peripheral device.

The translation means 20 in FIG. 2 is a roller-ball arrangement, but it is to be appreciated that this invention is not limited to this specific arrangement and may include any one or more of a trackball, touchpad, infra red arrangement, optical arrangement and the like.

It is also to be appreciated from this specification that the translation means 20 may be located on the first 16 or second 18 surfaces.

Furthermore, the translation means 20 can be a heat and/or pressure sensitive sensor (not shown) on the first surface 16 of the base member 12. The heat and/or pressure sensitive sensor will allow a user to create movement of a pointer on a peripheral device without displacing the base member's 12 position relative the work surface.

The first surface 16 of the embodiment shown in FIG. 4 shows a base member 12 that defines partitions 22 for receiving at least one of a user's digits (not shown). The partitions 22 assist in directing at least one of the user's digits to a desired place on the first surface 16 of the base member 12.

The sensors 14 permit a user to enter text, format documents, perform functions and/or manipulate a pointer on the peripheral device.

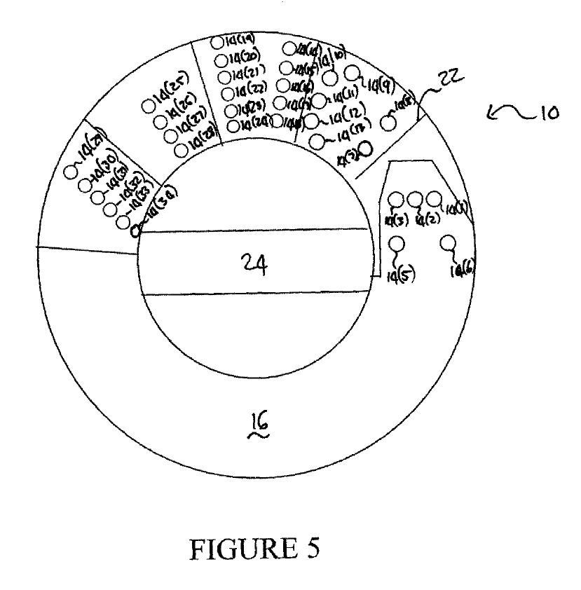

FIG. 5 shows yet another embodiment of the invention where the letters, numerals and functions sensors are allocated as follows:
14(1)—ENTER
14(2)—SHIFT
14(3)—NUMLOCK
14(5)—MOVE HUMAN INTERFACE DEVICE LEFT
14(6)—MOVE HUMAN INTERFACE DEVICE RIGHT
14(7)—SPACE
14(8)—BACK SPACE
14(9)—A
14(10)—E or 3
14(11)—I or 6
14(12)—O or 9
14(13)—U
14(14)—S or period (.)
14(15)—T or 2
14(16)—R or 5
14(17)—P or 8
14(18)—N or 0
14(19)—M or,
14(20)—L or 1
14(21)—D or 4
14(22)—B or 7
14(23)—H
14(24)—C
14(25)—K
14(26)—F
14(27)—G
14(28)—W
14(29)—V
14(30)—Y
14(31)—J
14(32)—X
14(33)—Z
14(34)—Q

It is to appreciated that the sensors 14 may be computer keyboard type sensors, heat sensors, touch sensors, and/or a touch screen.

The human interface device 10 includes securing means 24 for securing a user's hand to the device 10 and is in the form of a strap.

The inventor believes the invention has the advantage of allowing a user to use the human interface device with only one hand. This may be advantageous for persons with physical disabilities but also for persons requiring their other hand for another task.

What is claimed is:

1. A human interface device, the device including:
a base member having a first and second surface, wherein the first surface is an upper surface and is shaped and dimensioned to be received by a palmer aspect of a user's hand;
a plurality of sensors configured to allow the user to carry out numerous functions on a peripheral device connected to the human interface device; and,
wherein the plurality of sensors are configured to allow the user to, uni-dexterously, at least enter text, format a document and/or manipulate a pointer on the peripheral device.

2. The human interface device as claimed in claim 1, wherein the second surface is an under surface that is shaped and dimensioned to rest on and/or move relative to a work surface.

3. The human interface device as claimed in claim 1, wherein the base member includes translation means for translating movement of the human interface device relative the work surface to movement of a pointer on the peripheral device.

4. The human interface device as claimed in claim 3, wherein the translation means includes any one or more of a roller-ball mechanism, trackball, touchpad, infra red arrangement and/or optical arrangement.

5. The human interface device as claimed in claim 1, wherein the first surface includes any one or more of a roller-ball mechanism, trackball, touchpad, infra red arrangement and/or optical arrangement.

6. The human interface device as claimed in claim 1, wherein the first surface includes a heat and/or pressure sensitive sensor, the sensor configured to allow the user to move a pointer on the peripheral device without displacing the base member's position relative the work surface.

7. The human interface device as claimed in claim 1, wherein the first surface of the base member defines partitions for receiving at least one of a user's digits.

8. The human interface device as claimed in claim 1, wherein the sensors are configured to allow a user to enter text, format documents, perform functions and/or manipulate a pointer on the peripheral device.

9. The human interface device as claimed in claim 1, wherein the sensors are any one or more of conventional computer keyboard keys, heat sensors, touch sensors, and/or a touch screen sensors.

10. The human interface device as claimed in claim 1, wherein each sensor is configures to allow entry of at least one letter of the alphabet or numeral.

11. The human interface device as claimed in claim 1, wherein the device includes securing means for securing a user's hand to the device.
